(19) United States
(12) Patent Application Publication
(10) Pub. No.: US 2014/0287115 A1
(43) Pub. Date: Sep. 25, 2014

(54) Stick-mounted edible item-making assembly

(71) Applicants: Natalie A. Plank, Gardner, KS (US); Jennifer L. Grubbs, Hugoton, KS (US)

(72) Inventors: Natalie A. Plank, Gardner, KS (US); Jennifer L. Grubbs, Hugoton, KS (US)

(21) Appl. No.: 13/848,090

(22) Filed: Mar. 21, 2013

(51) Int. Cl. A21B 3/13

(52) U.S. Cl. CPC A21B 3/135
USPC 426/420; 425/116

(57) ABSTRACT

An assembly and method for preparing edible items on a stick, from material that may not be particularly pourable, using a mold, a mold compression piece and a stick.

### BACKGROUND OF THE INVENTION

A plethora of cutting and molding devices that are useful for creating stylishly shaped baked goods and confections have been developed in the prior art. Generally speaking, molding devices, or dies, are configured to be placed onto a flat baking surface, have a liquid dough mixture poured into their one or more segregated molds, and then placed in an oven for baking. Cutting devices, on the other hand, are made to be pressed down into a sheet of dough or prepared food in order to subdivide it into decorative shapes. Consequently, these two different sets of devices require that the edible material which they are used on to be either pourable (e.g., batter, liquefied confectionery material, etc) or roll-pressed into sheet form.

For example, a. typical cookie cutter is configured to cut a discrete piece of dough from a. broader dough sheet with each press. Obviously, then, the preliminary step of forming a sheet of dough with a rolling pin must be performed. And cutting shapes from a sheet is a process which, typically, leaves some amount of scrap dough that must be gathered and rolled into another sheet for a successive round of cutting, if dough is to not be simply discarded. This process may be repeated until the remaining scrap dough is insufficient to press into a sheet that is desirably thick and expansive enough to receive the entire cutter.

Molds render unnecessary the step of rolling edible material into sheet form, but they have their own limitation relative to the types of material that they can plausibly be used on. More specifically, they are useful only with edible material that is sufficiently liquid to be poured into them and flow to occupy their defined outlines. Most dough material is not that pourable, however.

Accordingly, the present inventors recognize an outstanding need to provide an assembly that is effective in molding less liquid forms of edible material (e.g., dough) into desired shapes, but obviate the step of forming sheets from which those shapes must be cut. Furthermore, they recognize a need for such an assembly to enable stick handles to be attached to those shaped food items. The instant invention substantially fulfills these needs.

### SUMMARY OF THE INVENTION

The present invention relates to apparatuses and methods for preparing edible items, and it is specifically directed to an assembly for molding dough and other edible material onto a stick, which is useful for handling the prepared item while eating, in preparation for the food material undergoing baking or another temperature-induced state transformation process. The present inventors refer to food items prepared using the instant invention as “snack pops.” For example, where such cookie dough is molded and stick-mounted using the present assembly and method, the resulting food items might be called “cookie pops.”

In its most basic sense, the invention is formed by three elements: (a) an artistically shaped mold or retainer device within which amorphous edible material is to be placed; (b) a plunging device that fits telescopically within the retainer to compress the dough into the perimeter shape of the retainer and a flat or specifically designed top face; and (c) a stick to be inserted through a slot opening in the perimeter wall of the retainer and serve as a handle for the snack pop item when the dough hardens thereabout. However, the present inventors anticipate that two or more such retainer devices (with at least one of them having two, opposingly aligned such slot openings formed in them) may be used to attached multiple, stylistically shaped edible masses to a single stick (e.g., a “double cookie pop”) within the spirit and scope of the present invention.

It should be noted that, for ease of discussion purposes, a wide range of “edible material” contemplated for use with the present assembly will often be referred to, hereinafter, as simply “dough,” even though much of that food matter does not fall within the actual definition of “dough” (e.g., confectionary materials, batters, etc.). Similarly, while it is contemplated, within the spirit and scope of the present invention, that such edible material may be exposed to either warmer or cooler air for the purpose of transforming it (e.g., solidifying, leavening, etc.) and bonding it to the stick, the term “baking” will be used, herein, as a shorthand reference meant to encompass all conceivable food preparation processes in which the edible material bonds to the stick, and not simply those involving convection.

In any event, unlike some snack-on-a-stick preparation assemblies of the prior art many of which are intended to hold liquid material that is to be freeze-molded (or otherwise cooled) onto a stick handle the mold piece of the present assembly is not meant to continue retaining its edible material during the food transformation process. Rather, once dough is placed within the retainer, pressed with the plunger, and impaled by the stick, the retainer is to be lifted from the dough (which remains rested on a cookie sheet or the like) and removed prior to baking

Therefore, it is an object of the present invention to provide a snack-on-a-stick preparation assembly to be used with more viscous unprepared material (e.g., dough) that need not be retained, during the baking/transformation process, in order to maintain its desired shape or ensure that the inserted stick remains upright while the material is transforming into its edible state. In one aspect of the invention, the dough mold piece is to be lifted and removed from the dough that is pressed into shape within it, prior to baking. Consequently, the entire outer edge and top face surfaces of the dough are to be fully exposed to convective heat during the baking process, and heat does not have to conduct through retainer wall material before conducting through any portion of the dough. This, presumably, reduces the necessary baking time from what it might otherwise be.

It is another object of the present invention to provide a dough-shaping assembly that eliminates the traditional step of spreading dough into a continuous sheet from which a desired shape must be press-cut using a cutting tool normally creating scrap dough that must be reamassed and, again, spread into a sheet for another round of cutting or is simply rendered waste. In an aspect of the invention, a desired amount of dough is placed into a shaped mold and is downwardly pressed by plunger so that it takes on the shape of the enclosure formed by the mold wall and the bottom face of the plunger without creating any waste product.

### BRIEF DESCRIPTION OF THE DRAWINGS

FIG. 1 is a top perspective view of the primary retainer device of a “two pop” embodiment of an edible item-making assembly according to the present invention;

FIG, 2 is a top perspective view of the compressing device of said assembly;

FIG. 3 is a top perspective view of the secondary retainer device of said assembly;

FIG. 4 illustrates said primary and secondary retainer devices, said compressing device and three alternate sticks of said assembly;

FIG. 5 illustrates dough being placed within said primary retainer;

FIG. 6 illustrates said compressing device being pressed against the dough within said primary retainer;

FIG. 7 illustrates said compressing device and said primary retainer being removed from the dough of a “one pop” edible item; and

FIG. 8 illustrates said compressing device and said primary retainer being removed from dough of a “two pop” edible item.

### DETAILED DESCRIPTION OF THE PREFERRED EMBODIMENTS

This disclosure, as defined by the claims that follow, relates to an apparatus assembly and a method of use therefor in molding dough into a defined shape, mounting it to a handling stick and baking it into a more edible state. As previously stated, the term “dough” is used in this disclosure to refer broadly to any edible material that is prone to retain the shape that it is molded into even after the molding device is removed from it. And the term “baking” is used to broadly refer to any process in which exposing the dough to a warmer or cooler environment causes it to transform into a more conventionally edible state.

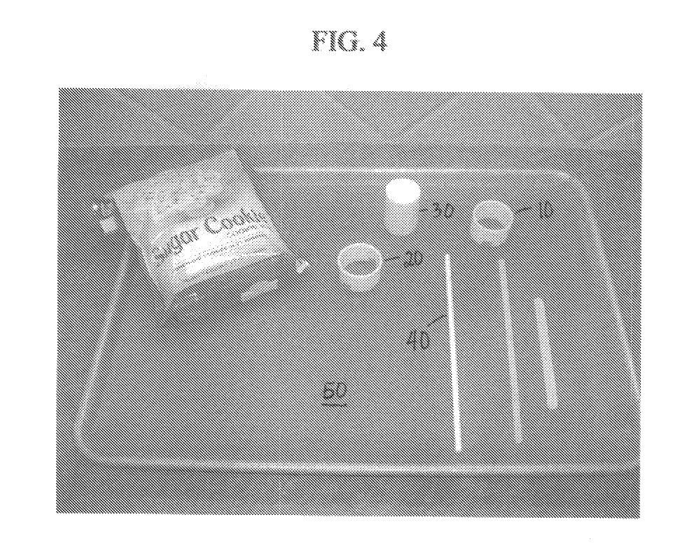

The components of “one pop” and “two pop” edible item-making embodiments of the present assembly (for preparing one shaped mass and two shaped masses of dough on a stick, respectively) are displayed in FIG. 4. The former embodiment comprises a dough-retaining means 10 (or “mold”), a dough-compressing device (or “plunger”) 30, and a dough-handling stick 40. The latter embodiment comprises those components as well as an additional, or secondary, dough retainer 20.

The primary retainer 10, as seen in FIG. 1, is formed by a closed sidewall 12 having an open top and bottom. Formed along the bottom edge of the sidewall 12 is a slot opening 14. The top edge 18 of the sidewall 12 is flanged outward to provide a retainer lifting surface. in the figures accompanying this disclosure, the retainer sidewall 12 is depicted in the form of a circle. However, it can be of virtually any shape that one might desire to make a food pop item into and that features a central body area which will completely envelop the portion of the stick 40 to be inserted within the retainer 10 (e.g., heart, tree, star, etc).

Whatever the retainer 10 shape is to be, the plunger 30, as shown in FIG. 2, must be shaped to telescopically slide into the retainer 10 as shown in FIGS. 6-8. Furthermore, the top face 32 of the plunger 30 is, preferably, fiat to best facilitate an even distribution of downward compression force to be applied to it by a preparer's hand. The plunger's bottom face (not shown) can be flat or configured to leave a design imprint on dough 60.

Finally, the stick 30 is straight and, preferably, has either a flattened cross-sectional profile like those typically found in frozen popsicles or a cylindrical profile like those typically found in confectionery lollipops. In either case, for a reason that will become clear later, the slot 14 formed within the retainer 10 should have a height dimension that is slightly greater than the vertical thickness of the stick 40.

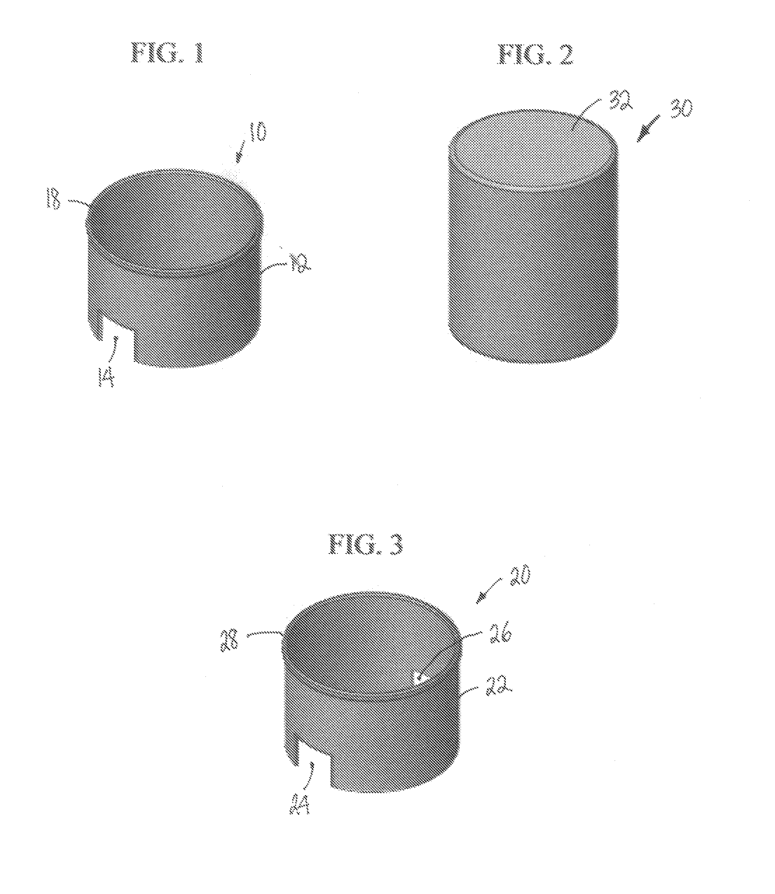

Primary and secondary retainers 10, 20 are for forming multiple edible masses along the same stick 40. A secondary retainer 20 is shown in FIG. 3. The primary retainer 10 and secondary retainer 20 may have identical or different shapes, but as can be gleaned from comparing FIGS. 1 and 3, they are necessarily different in the respect that a secondary retainer 20 includes two slots 24, 26, which are positioned along its sidewall 22 so as to enable a single, straight stick 40 to simultaneously protrude them as it extends entirely through the secondary retainer 20. These slots 24, 26 should be configured identically.

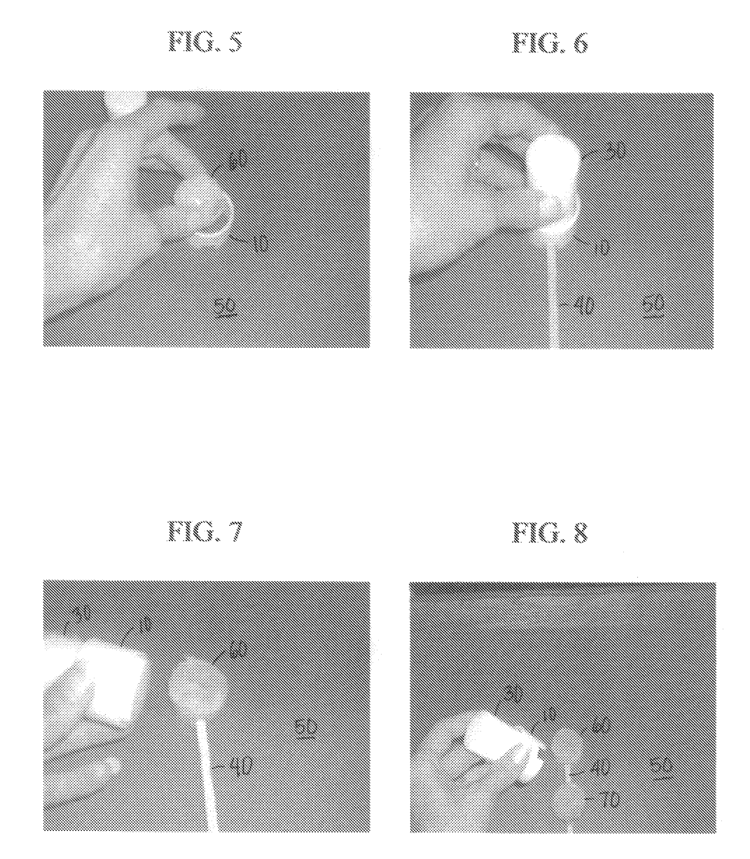

To prepare a food pop according to the present method, an unshapely lump of dough 60 is placed within the primary retainer 10 as it rests on a flat baking surface 50 (see FIG. 5). The stick 40 is then inserted through the slot 14 and into the dough 60 so that the leading end of the stick 40 resides at the approximate horizontal center of the retainer 10. The stick 40 should be disposed truly horizontal, and it should be inserted through the uppermost region of the slot 14 (assuming the slot 24 has a vertical dimension greater than the vertical thickness of the stick 40) so that it suspends slightly above the baking surface 50. In fact, depending upon the supportiveness of the pre-baked dough, it may he advisable to continue holding the stick 40 in parallel suspension above the baking surface 50 through the dough compression step that is to immediately follow.

Nevertheless, as shown in FIG. 6, the plunger 30 is then pressed down into the retainer 10, smashing the dough 60 into conformity with shrinking volume of enclosed space defined by the retainer sidewall 12 and the downward moving bottom face of the plunger 30. When that space is fully occupied by compressed dough 60, as is indicated by an increasing degree of resistance posed by the dough 60, the pressing should cease. When the height of the slot 14 is greater than the vertical thickness of the stick 40, compressing of the dough 60 will have the effect of ensuring that a layer of dough is formed underneath the stick so that the inserted portion of the stick 40 is completely enveloped by dough 60 for more secure dough-stick bonding. After the pressing step, the retainer 10 and plunger 30 are to be lifted up and away from the molded, stick-mounted dough mass 60 as illustrated in FIG. 7.

Where a second (or more) mass of dough 70 is to be mounted along a stick 40, as depicted in FIG. 8, the process is identical, except that the stick 40 is to be inserted completed though a second (or more) retainer 20 which holds that dough 70 before being pushed halfway through the first retainer 10 which holds another lump of dough 60.

After the aforedescribed molding steps are completed, the dough-mounted sticks should be baked to form cookie pops (or whatever type of food pop item that is to be produced from that dough upon its temperature-induced transformation into a more edible form) ready for consumption.

It is understood that substitutions and equivalents for and combinations of various elements set forth above may be obvious to those skilled in the art and may not represent a departure from the spirit of the invention. Therefore, the fill scope and definition of the present invention is to be set forth by the claims that follow.

What is claimed is:

1. A handle-mounted edible item-making assembly comprising:
means for retaining edible material, wherein the retaining means has a slot formed therein;
means for compressing the edible material within the retaining means;
means for handling the edible material after it is separated from the retaining means, wherein this handling means is insertable through the slot and, thereby, into the edible material.

2. The assembly of claim I, wherein said retaining means is substantially cylindrical.

3. The assembly of claim 1, wherein said compressing means fits telescopically into said retaining means.

4. The assembly of claim I, wherein said retaining means further comprises a flange for lifting said retaining means away from said edible material.

5. The assembly of claim 1, further comprising a second means for retaining edible material, wherein this second retaining means has two slots formed therein, wherein these slots are configured and positioned to be simultaneously protruded by said handling means;

6. The assembly of claim 5, wherein said second retaining means is substantially cylindrical.

7. The assembly of claim 5, wherein said compressing means also tits telescopically into said second retaining means.

8. The assembly of claim 5, wherein said second retaining means further comprises a flange for lifting said second retaining means away from said edible material.

9. The assembly of claim 5, wherein said first and second retaining means have different shapes and wherein said assembly further comprises a second means for compressing the edible material within said second retaining means, wherein this second compressing means fits telescopically into said second retaining means,

10. A stick-mounted edible item-making assembly comprising:
a retainer for retaining edible material, wherein the retainer is formed by a closed sidewall having a slot opening formed along its bottom, an open top and an open bottom;
a compressing device that telescopically fits within the retainer to compress edible material into the shape of an enclosure formed by the compressing device and retainer sidewalk and
a stick that is insertable through the slot opening and, thereby, into edible material disposed within the retainer.

11. The assembly of claim 10, herein said retainer is substantially cylindrical,

12. The assembly of claim 10, wherein a flange is disposed along said sidewalk the flange for lifting said retainer away from edible material disposed therewithin.

13. The assembly of claim 10, further comprising a second retainer for retaining edible material, wherein this second retainer is formed by a closed sidewall having two slots formed along its bottom, an open top and an open bottom, and wherein these two slots are configured and positioned to be simultaneously protruded by said stick;

14. The assembly of claim 13, wherein said second retainer is substantially cylindrical.

15. The assembly of claim 13, wherein said compressing device fits telescopically into said second retainer to compress edible material into the shape of an enclosure formed by the compressing device and second retainer sidewall.

16. The assembly of claim 13, further comprising a second compressing device that fits telescopically into said second retainer to compress edible material into the shape of an enclosure formed by this second compressing device and said second retainer sidewall.

17. A method for making a stick-mounted edible item, the method comprising:
depositing edible material into a retainer that is formed by a closed sidewall having a slot opening formed along its bottom, an open top and an open bottom;
inserting a stick through the slot opening and into the edible material;
pressing the edible material down within the retainer such that the edible material is formed into the shape of the retainer sidewalk
separating the retainer from the stick-mounted edible material; and
heating or cooling the edible material.

18. The method of claim 17, wherein said edible material is selected from the group consisting of: confectionery material, cookie dough, cake batter and combinations thereof.
